(19) United States
(12) Patent Application Publication
(10) Pub. No.: US 2018/0118162 A1
(43) Pub. Date: May 3, 2018

(54) Vehicle Anti-Theft Device

(71) Applicant: Julio Rosales, Miami, FL (US)

(72) Inventor: Julio Rosales, Miami, FL (US)

(21) Appl. No.: 15/337,462

(22) Filed: Oct. 28, 2016

(51) Int. Cl. B60R 25/22; B60R 25/40; G07C 9/00

(52) U.S. Cl. CPC B60R 25/225; G07C 9/00896; B60R 25/403

(57) ABSTRACT

A vehicle anti-theft device for deterring vehicle theft includes a housing that is coupled to a sidewall of the vehicle. A first power module and an actuator are coupled to the housing and are positioned in an internal space defined by the housing. The actuator is operationally coupled to the first power module. A brake pedal, which is operationally coupled to a braking system of the vehicle, is pivotally coupled to the sidewall of the vehicle proximate to the housing. A first coupler is coupled to the actuator and extends from an opening in the housing. A second coupler, which is complementary to the first coupler, is coupled to the brake pedal. The actuator is positioned to motivate the first coupler to reversibly and selectively couple to the second coupler when the brake pedal is depressed. The braking system of the vehicle is engageable to reduce the risk of theft.

### BACKGROUND OF THE DISCLOSURE

### Field of the Disclosure

The disclosure relates to anti-theft devices and more particularly pertains to a new anti-theft device for deterring vehicle theft.

### SUMMARY OF THE DISCLOSURE

An embodiment of the disclosure meets the needs presented above by generally comprising a housing that is coupled to a sidewall of the vehicle. A first power module and an actuator are coupled to the housing and are positioned in an internal space defined by the housing. The actuator is operationally coupled to the first power module. A brake pedal, which is operationally coupled to a braking system of the vehicle, is pivotally coupled to the sidewall of the vehicle proximate to the housing. A first coupler is coupled to the actuator and extends from an opening in the housing. A second coupler, which is complementary to the first coupler, is coupled to the brake pedal. The actuator is positioned to motivate the first coupler to reversibly and selectively couple to the second coupler when the brake pedal is depressed. The braking system of the vehicle is engageable to reduce the risk of theft.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a vehicle anti-theft device according to an embodiment of the disclosure.

FIG. 2 is a front cross-sectional view of an embodiment of the disclosure.

FIG. 3 is a side cross-sectional view of an embodiment of the disclosure.

FIG. 4 is a side cross-sectional view of an embodiment of the disclosure.

FIG. 5 is a block diagram of an embodiment of the disclosure.

### DESCRIPTION OF THE PREFERRED EMBODIMENT

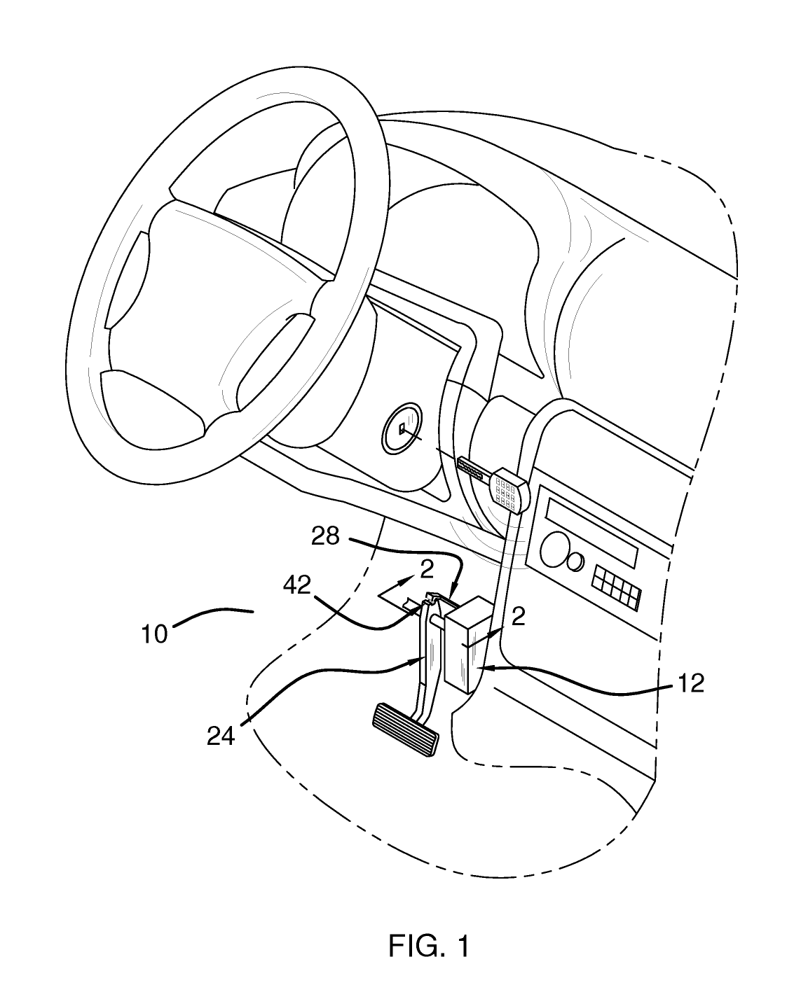

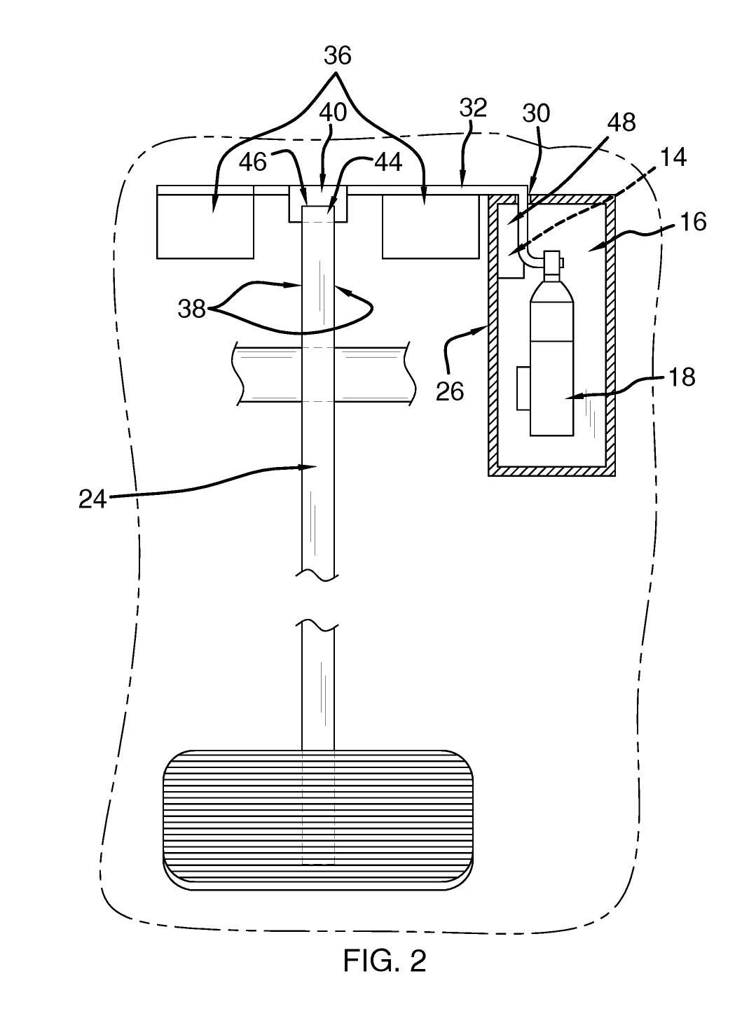

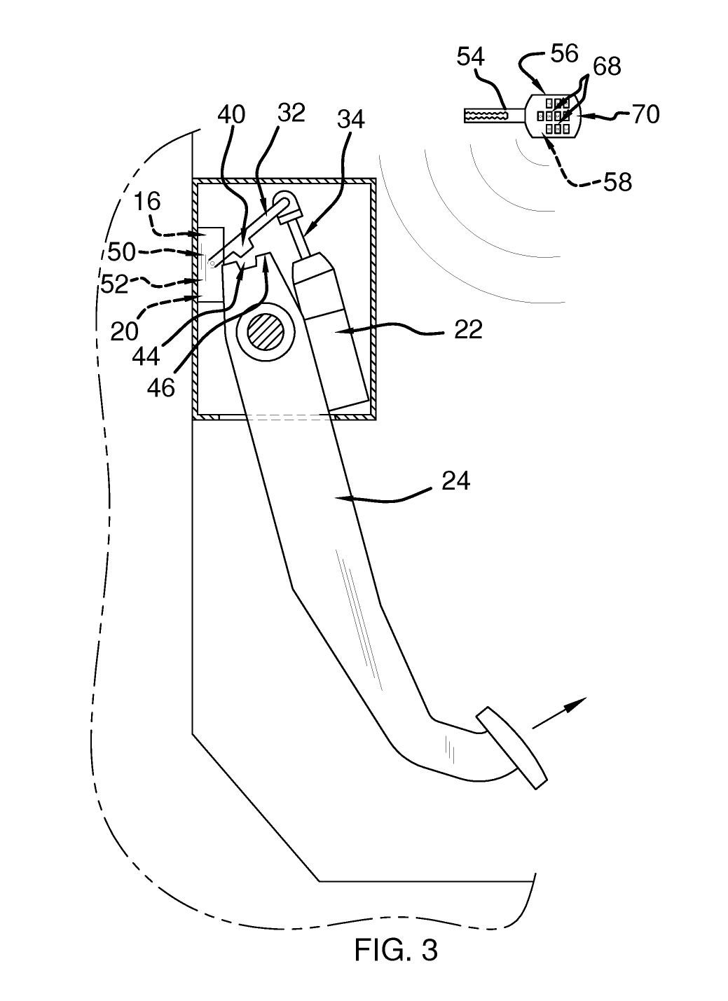

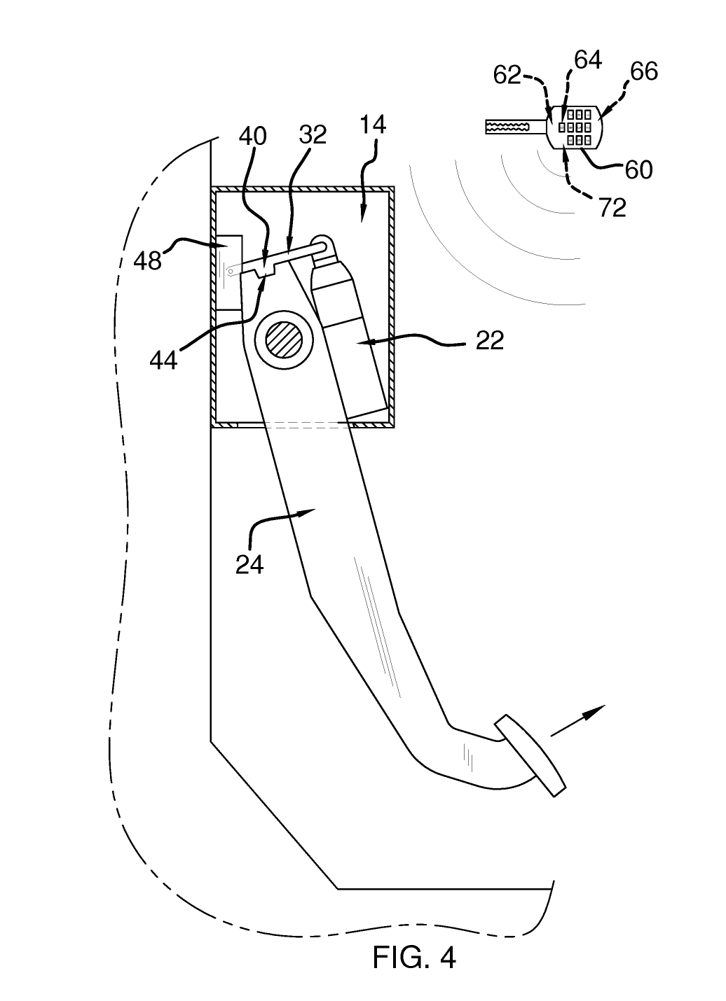

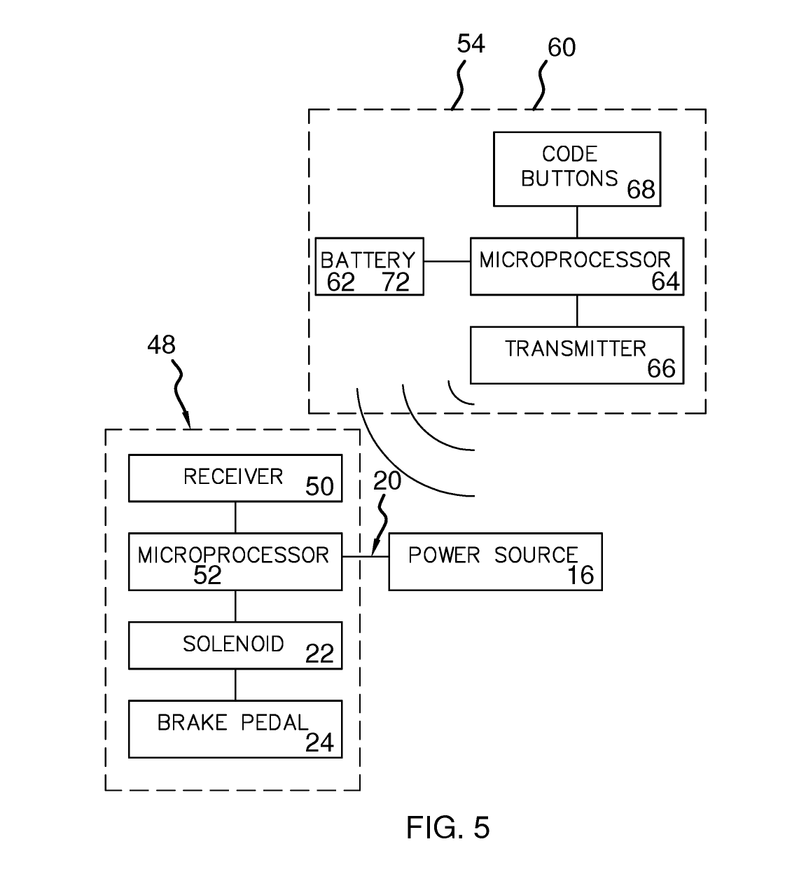

With reference now to the drawings, and in particular to FIGS. 1 through 5 thereof, a new anti-theft device embodying the principles and concepts of an embodiment of the disclosure and generally designated by the reference numeral 10 will be described.

As best illustrated in FIGS. 1 through 5, the vehicle anti-theft device 10 generally comprises a housing 12 that defines an internal space 14. The housing 12 is coupled to a sidewall of the vehicle. In one embodiment, the housing 12 is substantially rectangularly box shaped.

A first power module 16 and an actuator 18 are coupled to the housing 12 and are positioned in the internal space 14. The actuator 18 is operationally coupled to the first power module 16. In one embodiment, the first power module 16 comprises wiring 20 that is coupled to a battery of the vehicle. In another embodiment, the actuator 18 comprises a solenoid 22.

A brake pedal 24 is pivotally coupled to the sidewall of the vehicle proximate to the housing 12. The brake pedal 24 is operationally coupled to a braking system of the vehicle. The brake pedal 24 is depressible to engage the braking system. In one embodiment, the brake pedal 24 is positioned proximate to a left side 26 of the housing 12.

A first coupler 28 is coupled to the actuator 18 and extends from an opening 30 that is positioned in the housing 12. In one embodiment, the first coupler 28 comprises a bar 32 that is pivotally coupled to and extends from a piston 34 of the solenoid 22. In one embodiment, the bar 32 is L-shaped. In another embodiment, the bar 32 is arcuate proximate to the piston 34.

A pair of brackets 36 is coupled to the sidewall. Each bracket 36 is positioned on a respective opposing side 38 of the brake pedal 24. Each bracket 36 is rotationally coupled to the bar 32. The bar 32 is rotatable within the brackets 36 as the piston 34 is extended from and retracted into the solenoid 22. A tab 40 is coupled to and extends from the bar 32. The tab 40 is positioned substantially equally distant from the brackets 36, such that the tab 40 is vertically aligned with the brake pedal 24.

A second coupler 42 is coupled to the brake pedal 24. The second coupler 42 is complementary to the first coupler 28. The first coupler 28 is positioned on the actuator 18 such that the actuator 18 is positioned to motivate the first coupler 28 to reversibly and selectively couple to the second coupler 42 when the brake pedal 24 is depressed. The brake pedal 24 is lockable and the braking system of the vehicle is engageable to reduce the risk of theft. In one embodiment, the second coupler 42 comprises a slot 44 that is positioned in an end 46 of the brake pedal 24. The slot 44 is complementary to the tab 40. The slot 44 is positioned in the brake pedal 24 such that the slot 44 is positioned to couple to the tab 40 as the bar 32 is rotated by the piston 34.

A controller 48 is coupled to the first housing 12 and is positioned in the internal space 14. The controller 48 is operationally coupled to the actuator 18 and the first power module 16. The controller 48 is positioned to compel the actuator 18 to motivate the first coupler 28 to couple to the second coupler 42 when the brake pedal 24 is depressed. The brake pedal 24 is locked and the braking system of the vehicle remains engaged to reduce the risk of theft. In one embodiment, the controller 48 comprises a receiver 50 and a first computer processing unit 52.

A remote 54 is operationally coupled to the controller 48. The remote 54 is positioned to compel the controller 48 to motivate the solenoid 22 to decouple the first coupler 28 from the second coupler 42 such that the brake pedal 24 is unlocked and the braking system of the vehicle is disengaged. The remote 54 comprises a shell 56 that defines an interior space 58. In one embodiment, the shell 56 comprises a key 60 for the vehicle. The key 60 requires that the brake pedal 24 be depressed for removal of the key 60 from an ignition switch of the vehicle.

A second power module 62 is coupled to the shell 56 and is positioned in the interior space 58. In one embodiment, the second power module 62 comprises at least one battery 72. A second computer processing unit 64 and a transmitter 66 are coupled to the shell 56 and are positioned in the interior space 58. The second computer processing unit 64 is operationally coupled to the second power module 62. The transmitter 66 is operationally coupled to the second computer processing unit 64. The transmitter 66 is wirelessly coupled to the receiver 50.

A key pad 68 is positioned on an exterior 70 of the shell 56. The key pad 68 is operationally coupled to the second computer processing unit 64. The key pad 68 is positioned for entry of a code that will enable the second computer processing unit 64 to compel the transmitter 66 to signal the controller 48 to compel the solenoid 22 to decouple the first coupler 28 from the second coupler 42 so that the braking system is disengaged.

In use the controller 48 is positioned to compel the actuator 18 to motivate the first coupler 28 to couple to the second coupler 42 when the brake pedal 24 is depressed. The brake pedal 24 is locked and the braking system of the vehicle remains engaged to reduce the risk of theft. The remote 54 is positioned to compel the controller 48 to motivate the solenoid 22 to decouple the first coupler 28 from the second coupler 42 such that the brake pedal 24 is unlocked and the braking system of the vehicle is disengaged. The key pad 68 is positioned for entry of a code that will enable the second computer processing unit 64 to compel the transmitter 66 to signal the controller 48 to compel the solenoid 22 to decouple the first coupler 28 from the second coupler 42 so that the braking system is disengaged.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle anti-theft device comprising:
a housing defining an internal space, said housing being coupled to a sidewall of the vehicle;
a first power module coupled to said housing and positioned in said internal space;
an actuator coupled to said housing and positioned in said internal space, said actuator being operationally coupled to said first power module;
a brake pedal pivotally coupled to the sidewall of the vehicle proximate to said housing, said brake pedal being operationally coupled to a braking system of the vehicle such that said brake pedal is depressible to engage the braking system;
a first coupler coupled to said actuator and extending from an opening positioned in said housing;
a second coupler coupled to said brake pedal, said second coupler being complementary to said first coupler, wherein said first coupler is positioned on said actuator such that said actuator is positioned to motivate said first coupler to reversibly and selectively couple to said second coupler when said brake pedal is depressed, such that said brake pedal is lockable and the braking system of the vehicle is engageable to reduce the risk of theft; and
wherein said first coupler is positioned on said actuator such that said actuator is positioned to motivate said first coupler to reversibly and selectively couple to said second coupler when said brake pedal is depressed, such that said brake pedal is lockable and the braking system of the vehicle is engageable to reduce the risk of theft.

2. The device of claim 1, further including said housing being substantially rectangularly box shaped.

3. The device of claim 1, further including said first power module comprising wiring coupled to a battery of the vehicle.

4. The device of claim 1, further including said actuator comprising a solenoid.

5. The device of claim 1, further including said brake pedal being positioned proximate to a left side of said housing.

6. The device of claim 4, further comprising:
said first coupler comprising:
a bar pivotally coupled to and extending from a piston of said solenoid, said bar being L-shaped, said bar being arcuate proximate to said piston,
a pair of brackets coupled to said sidewall, each said bracket being positioned on a respective opposing side of said brake pedal, each said bracket being rotationally coupled to said bar such that said bar is rotatable within said brackets as said piston is extended from and retracted into said solenoid, and
a tab coupled to and extending from said bar, said tab being positioned substantially equally distant from said brackets such that said tab is vertically aligned with said brake pedal;
said second coupler comprising a slot positioned in an end of said brake pedal, said slot being complementary to said tab; and
wherein said slot is positioned in said brake pedal such that said slot is positioned to couple to said tab as said bar is rotated by said piston.

7. The device of claim 4, further including a controller coupled to said first housing and positioned in said internal space, said controller being operationally coupled to said actuator and said first power module, wherein said controller is positioned to compel said actuator to motivate said first coupler to couple to said second coupler when said brake pedal is depressed, such that said brake pedal is locked and the braking system of the vehicle remains engaged to reduce the risk of theft.

8. The device of claim 7, further including a remote operationally coupled to said controller, wherein said remote is positioned to compel said controller to motivate said solenoid to decouple said first coupler from said second coupler such that said brake pedal is unlocked and the braking system of the vehicle is disengaged.

9. The device of claim 8, further comprising:
said controller comprising a receiver and a first computer processing unit;
said remote comprising:
a shell defining an interior space,
a second power module coupled to said shell and positioned in said interior space, said second power module comprising at least one battery,
a second computer processing unit, said second computer processing unit being coupled to said shell and positioned in said interior space, said second computer processing unit being operationally coupled to said second power module,
a transmitter, said transmitter being coupled to said shell and positioned in said interior space, said transmitter being operationally coupled to said second computer processing unit, said transmitter being wirelessly coupled to said receiver, and
a keypad positioned on an exterior of said shell, said keypad being operationally coupled to said second computer processing unit; and
wherein said remote is positioned to signal said controller to motivate said solenoid to decouple said first coupler from said second coupler such that said brake pedal is unlocked and the braking system of the vehicle is disengaged, wherein said keypad is positioned for entry of a code that will enable said second computer processing unit to compel said transmitter to signal said controller to compel said solenoid to decouple said first coupler from said second coupler, such that the braking system is disengaged.

10. The device of claim 9, further including said shell comprising a key for the vehicle, said key requiring that said brake pedal be depressed for removal of said key from an ignition switch of the vehicle.

11. A vehicle anti-theft device comprising:
a housing defining an internal space, said housing being coupled to a sidewall of the vehicle, said housing being substantially rectangularly box shaped;
a first power module coupled to said housing and positioned in said internal space, said first power module comprising wiring coupled to a battery of the vehicle;
an actuator coupled to said housing and positioned in said internal space, said actuator being operationally coupled to said first power module, said actuator comprising a solenoid;
a brake pedal pivotally coupled to the sidewall of the vehicle proximate to said housing, said brake pedal being operationally coupled to a braking system of the vehicle such that said brake pedal is depressible to engage the braking system, said brake pedal being positioned proximate to a left side of said housing;
a first coupler coupled to said actuator and extending from an opening positioned in said housing, said first coupler comprising:
a bar pivotally coupled to and extending from a piston of said solenoid, said bar being L-shaped, said bar being arcuate proximate to said piston,
a pair of brackets coupled to said sidewall, each said bracket being positioned on a respective opposing side of said brake pedal, each said bracket being rotationally coupled to said bar such that said bar is rotatable within said brackets as said piston is extended from and retracted into said solenoid, and
a tab coupled to and extending from said bar, said tab being positioned substantially equally distant from said brackets such that said tab is vertically aligned with said brake pedal;
a second coupler coupled to said brake pedal, said second coupler being complementary to said first coupler, wherein said first coupler is positioned on said actuator such that said actuator is positioned to motivate said first coupler to reversibly and selectively couple to said second coupler when said brake pedal is depressed, such that said brake pedal is lockable and the braking system of the vehicle is engageable to reduce the risk of theft, said second coupler comprising a slot positioned in an end of said brake pedal, said slot being complementary to said tab, wherein said slot is positioned in said brake pedal such that said slot is positioned to couple to said tab as said bar is rotated by said piston;
a controller coupled to said first housing and positioned in said internal space, said controller being operationally coupled to said actuator and said first power module, wherein said controller is positioned to compel said actuator to motivate said first coupler to couple to said second coupler when said brake pedal is depressed, such that said brake pedal is locked and the braking system of the vehicle remains engaged to reduce the risk of theft, said controller comprising a receiver and a first computer processing unit;
a remote operationally coupled to said controller, wherein said remote is positioned to compel said controller to motivate said solenoid to decouple said first coupler from said second coupler such that said brake pedal is unlocked and the braking system of the vehicle is disengaged, said remote comprising:
a shell defining an interior space, said shell comprising a key for the vehicle, said key requiring that said brake pedal be depressed for removal of said key from an ignition switch of the vehicle,
a second power module coupled to said shell and positioned in said interior space, said second power module comprising at least one battery,
a second computer processing unit, said second computer processing unit being coupled to said shell and positioned in said interior space, said second computer processing unit being operationally coupled to said second power module,
a transmitter, said transmitter being coupled to said shell and positioned in said interior space, said transmitter being operationally coupled to said second computer processing unit, said transmitter being wirelessly coupled to said receiver, and
a keypad positioned on an exterior of said shell, said keypad being operationally coupled to said second computer processing unit, wherein said keypad is positioned for entry of a code that will enable said second computer processing unit to compel said transmitter to signal said controller to compel said solenoid to decouple said first coupler from said second coupler, such that the braking system is disengaged; and
wherein said controller is positioned to compel said actuator to motivate said first coupler to couple to said second coupler when said brake pedal is depressed, such that said brake pedal is locked and the braking system of the vehicle remains engaged to reduce the risk of theft, wherein said remote is positioned to compel said controller to motivate said solenoid to decouple said first coupler from said second coupler such that said brake pedal is unlocked and the braking system of the vehicle is disengaged, wherein said keypad is positioned for entry of a code that will enable said second computer processing unit to compel said transmitter to signal said controller to compel said solenoid to decouple said first coupler from said second coupler, such that the braking system is disengaged.
